(19) United States
(12) Patent Application Publication
(10) Pub. No.: US 2026/0291261 A1
(43) Pub. Date: Sep. 24, 2026

(54) SYSTEMS AND METHODS FOR OPTIMIZING LIFETIME AND EFFICIENCY OF A BATTERY ENERGY STORAGE SYSTEM

(71) Applicant: Fluence Energy, LLC, Arlington, VA (US)

(72) Inventors: Mohamamdhassan Abdollahi Sofla, Raleigh, NC (US); Isaiah Dallas Jefferson, Jr., Mitchellville, MD (US)

(73) Assignee: Fluence Energy, LLC, Arlington, VA (US)

(21) Appl. No.: 18/873,865

(22) PCT Filed: Sep. 26, 2024
(86) PCT No.: PCT/US2024/048633

§ 371 Date: Dec. 11, 2024

Related U.S. Application Data
(60) Provisional application No. 63/541,154, filed on Sep. 28, 2023.

(51) Int. Cl. H02J 7/44; H02J 7/00; H02J 7/34; H02J 7/50; H02J 7/90; H02J 7/94; H02J 7/96

(52) U.S. Cl. CPC H02J 7/44; H02J 7/34; H02J 7/585; H02J 7/855; H02J 7/933; H02J 7/94; H02J 7/96; H02J 7/977; H02J 2207/20

(57) ABSTRACT

An energy storage system includes a power conversion system (PCS); and a plurality of energy storage nodes. The energy storage nodes include a battery storage element, and a control system to receive battery data from the battery storage element. The energy storage system further includes a control system coupled to the energy storage nodes and configured to receive or store a required power flow. The control system is configured to receive or store the required power flow for an electrical application. The control system is configured to dispatch the required power flow across the plurality of energy storage nodes based on at least two of: (1) a battery cost lifetime of the battery storage element; (2) a PCS cost lifetime of the PCS; and (3) an operating efficiency of the battery storage element and the PCS.

### CROSS-REFERENCE TO RELATED APPLICATIONS

This application claims priority to U.S. Provisional Patent Application No. 63/541,154 filed on Sep. 28, 2023, titled “Systems and Methods for Optimizing Lifetime and Efficiency of a Battery Energy Storage System” the entire disclosure of which is incorporated by reference herein.

### TECHNICAL FIELD

The present subject matter relates to an energy storage system that includes a plurality of energy storage nodes. The present subject matter also encompasses controlling a dispatch of the energy storage nodes using an optimized dispatch based on a battery cost lifetime of a battery storage element, a power conversion (PCS) cost lifetime of a PCS, or an operating efficiency of the battery storage element and the PCS.

### BACKGROUND

An energy storage system, such as a battery energy storage system (BESS), can be set up in a distributed manner to satisfy safety and economical concerns. The energy storage system often includes associated components, such as many energy storage nodes that each include one or more enclosures that houses many batteries inside, and power conversion systems. Typically, the energy storage system includes a control system that monitors the energy storage nodes.

The BESS is often made up of large, often expensive components designed to be as efficient as possible at performing the tasks of creating, storing, or provisioning energy. Downtime for these components can incur prohibitively high costs, and therefore maintenance and replacement of degraded components can come with rush fees, on top of the costs of parts and labor in repair and replacement. Consequently, operators of energy storage systems wish to operate their energy storage systems as efficiently as possible, at least in part with consideration towards maintenance and replacement costs.

However, determining efficient use is a difficult task. Usually, operators first and foremost concern is meeting energy demands within the terms of their contract: provide a certain number of kilowatts within a time period, or provide a certain number of kilowatt hours during a time span. However, the existing energy storage system controls do not consider the operating efficiency of PCSs (e.g., inverters) and batteries. This lack of consideration can cause inefficient performance in times that there are flexibility in power dispatch issued by energy storage system controls.

After meeting contractual obligations, determining efficiency within the bounds of the contractual obligations is less clear. In some circumstances, running components at a low but constant demand is efficient, but certain components such as inverters are maximally efficient at 75%-80% of capacity. However, when an inverter is running at that maximally efficient capacity, connected energy storage nodes may be running at an inefficient capacity, and charging or discharging outside of an optimal range. Further, energy efficiency does not necessarily correlate to lifetime efficiency of a component. It may be better to run certain components, such as inverters, at a low operational efficiency, and lose energy to heat, but increase the lifetime or time to maintenance of that inverter.

The end of life (EOL) of batteries in energy storage systems is significantly influenced by power control strategies. Extensive research has demonstrated that the EOL can be improved when batteries are controlled using optimized methods. The overall operator's profit of an energy storage system relies on the EOL of its batteries. The EOL of inverters and costly maintenance is influenced by the stress factors defined for power conversion systems. Thus, the excessive stress impacts the inverters EOL and may require costly part replacements.

These contrasting demands of meeting contract requirements and maximizing operational and lifetime efficiency across different categories of components are difficult. Particularly when different components linked together have different maximally efficient operating capacities, and particular components have different capacities which maximize either operational or lifetime efficiency.

Currently, power control is performed without considering degradation factors of batteries. The current method of commanding the PCSs (e.g., inverters) is also negligent of the stress factors on the inverters. In the face of these multivariate problems with the current power control tools, some operators merely guess at efficient operating capacities, and hope that they are not overpaying for or losing out on excess energy dissipated as heat, and that their components are not undergoing excessive stress requiring early maintenance or replacement.

### SUMMARY

In a first example, an energy storage system 101 includes a power conversion system (PCS) 104; and a plurality of energy storage nodes 105A-N. The plurality of energy storage nodes 105A-N include a battery storage element 106, and a control subsystem 110 to receive battery data 111A-N from the battery storage element 106, PCS data 157A-N from the power conversion system 104, or a combination thereof. The energy storage system 101 further includes a control system 115 coupled to the plurality of energy storage nodes 105A-N and configured to receive or store a required power flow 112. The control system 115 is configured to receive or store the required power flow 112 for an electrical application 103. The control system 115 is configured to dispatch the required power flow 112 across the plurality of energy storage nodes 105A-N based on at least two of: (a) a battery cost lifetime 131 of the battery storage element 106; (b) a PCS cost lifetime 132 of the PCS 104; and (c) an operating efficiency 133 of the battery storage element 106 and the PCS 104.

In a second example, a non-transitory computer-readable medium 313, 353 includes optimized dispatch programming 330A-B. Execution of the optimized dispatch programming 330A-B by one or more processors 312, 352 configures one or more controllers 110, 115, 170-173 to receive or store a required power flow 112 for an electrical application 103. Execution of the optimized dispatch programming 330A-B by the one or more processors 312, 352 configures the one or more controllers 110, 115, 170-173 to dispatch the required power flow 112 across a plurality of energy storage nodes 105A-N based on at least two of: (a) a battery cost lifetime 131 of a battery storage element 106; (b) a power conversion system cost lifetime 132 of a power conversion system (PCS) 104; and (c) an operating efficiency 133 of the battery storage element 106 and the PCS 104.

In a third example, a method 600 includes receiving or storing a required power flow 112 for an electrical application 103. The method further includes dispatching the required power flow 112 across a plurality of energy storage nodes 105A-N based on at least two of: (a) a battery cost lifetime 131 of a battery storage element 106; (b) a power conversion system cost lifetime 132 of a power conversion system (PCS) 104; and (c) an operating efficiency 133 of the battery storage element 106 and the PCS 104.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A depicts a system that includes an energy storage system, energy system, and an electrical application.

FIG. 1B depicts a battery array, an array controller, and core controllers of an example architecture of a control system of FIG. 1A.

FIG. 1C depicts the array controller, the core controllers, node controllers, and enclosure controllers in the example architecture of the control system of FIGS. 1A-B.

FIG. 1D depicts a power conversion system of a battery core of FIG. 1A-C.

FIG. 2A illustrates a first energy storage node of a plurality of energy storage nodes of the energy storage system of FIGS. 1A-C coupled to the electrical application.

FIG. 2B illustrates a first energy storage node that includes a plurality of battery cubes and a plurality of power conversion systems coupled to a DC link (DC bus).

FIG. 3A is a high-level functional block diagram of the energy storage system of FIG. 1A that depicts components of the control system and a control subsystem for optimized dispatch of the energy storage nodes.

FIG. 3B is another high-level functional block diagram of the energy storage system of FIGS. 1B-C that depicts components of the control system with various controllers for optimized dispatch of the energy storage nodes.

FIG. 4A is an optimized dispatch protocol for the energy storage system of FIG. 1A that is implemented by the control system, the control subsystem, and the plurality of energy storage nodes.

FIG. 4B is the optimized dispatch protocol for the energy storage system of FIGS. 1B-C that is implemented by the various controllers of the control system and the plurality of energy storage nodes.

FIG. 5 is a cutaway view of the first energy storage node of the plurality of energy storage nodes and shows details of a plurality of battery storage elements.

FIG. 6 is a flowchart of a method that can be implemented for optimized dispatch of the energy storage system.

FIG. 7A is a battery ideal operation profile.

FIG. 7B is a PCS ideal operation profile.

FIG. 8 is a block diagram of the optimized dispatch protocol implemented in the optimized dispatch programming.

FIG. 9 is another block diagram of the optimized dispatch protocol implemented in the optimized dispatch programming.

Parts Listing

| | |
|---|---|
| 100 | System |
| 101 | Energy Storage System |
| 102 | Energy System |
| 103 | Electrical Application |
| 104, 104A-N | Power Conversion Systems |
| 105A-N | Energy Storage Nodes |
| 106, 106A-N | Battery Storage Elements |
| 107, 107A-N | Power Conversion Subsystems |
| 108 | Transformer |
| 109 | Energy Source |
| 110 | Control Subsystem |
| 111A-N | Battery Data |
| 112 | Required Power Flow |
| 115 | Control System |
| 116A-N | Battery States |
| 116A | State of Charge (SOC) |
| 120 | Physical Space |
| 125 | Power Bus |
| 131 | Battery Cost Lifetime |
| 132 | PCS Cost Lifetime |
| 133 | Operating Efficiency |
| 150 | Battery Array |
| 151A-N | Battery Cores |
| 152 | Power Conversion Unit |
| 153 | HVAC Equipment |
| 154 | Fan |
| 155 | Condenser |
| 156 | Heater |
| 157A-N | PCS Data |
| 160 | PCS Controller |
| 161 | Network Communication Interface |
| 162 | Processor |
| 163 | Memory |
| 164A-N | Environmental Sensors |
| 165A-N | Environmental Condition Data |
| 168A-N | PCS Sensors |
| 170 | Array Controller |
| 171, 171A-N | Node Controllers |
| 172, 172A-N | Core Controllers |
| 173, 173A-N | Enclosure Controllers |
| 174 | Market Dispatch Unit Controller |
| 183, 183A-B | Power Commands |
| 205 | Power Inverter |
| 210 | Rectifier |
| 215 | DC-DC Converter |
| 225 | DC Link (DC Bus) |
| 230, 230A-N | Battery Cubes |
| 305, 305A-N | Network |
| 311, 351, 391 | Network Communication Interface |
| 312, 352, 392 | Processor |
| 313, 353, 393 | Memory |
| 315A-N | Sensors |
| 330, 330A-C | Maintenance Management Programming |
| 365A-N | Environmental Condition Data |
| 370A-N | Environmental Sensors |
| 375A-N | Battery Sensors |
| 380A-N | System Data |
| 381A-N | Component Data |
| 390 | Maintenance Management System |
| 395A-N | Analytical Models |
| 396A-N | Atypical Conditions |
| 397 | Maintenance Plan |
| 398A-N | Time Periods |
| 399A-N | Atypical Condition Patterns |
| 400 | Maintenance Management Protocol |
| 500 | Enclosure |
| 600 | Method |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

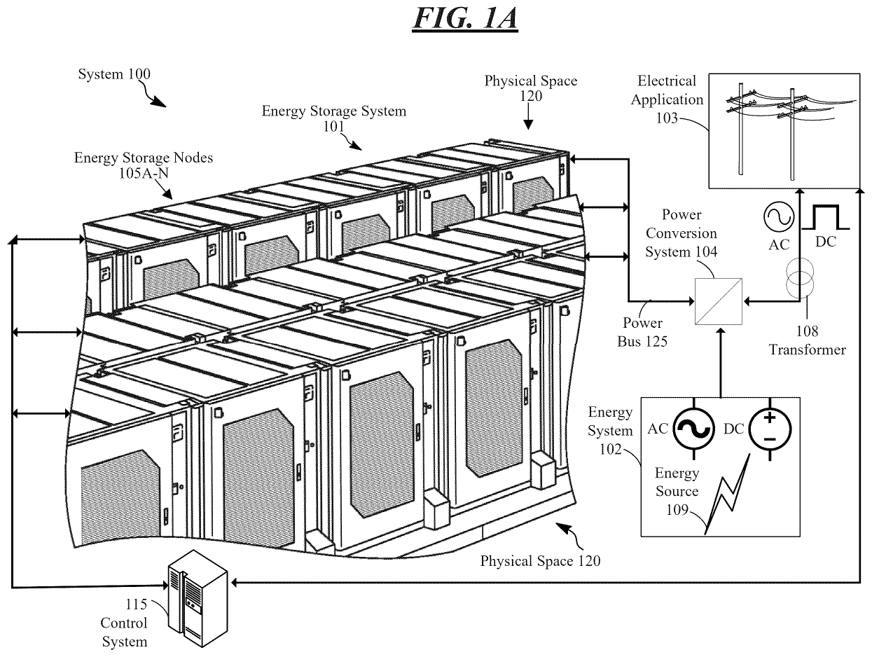

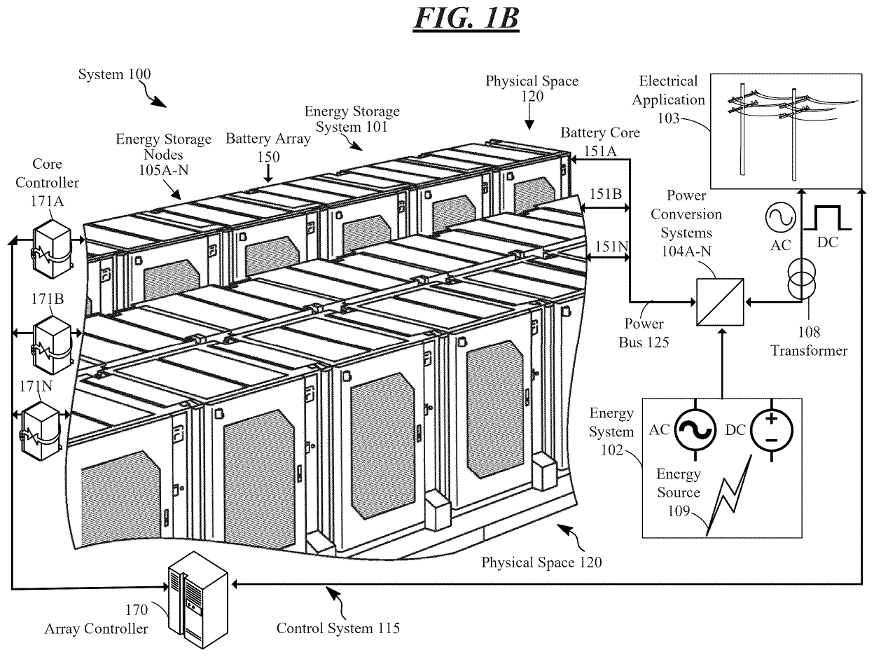

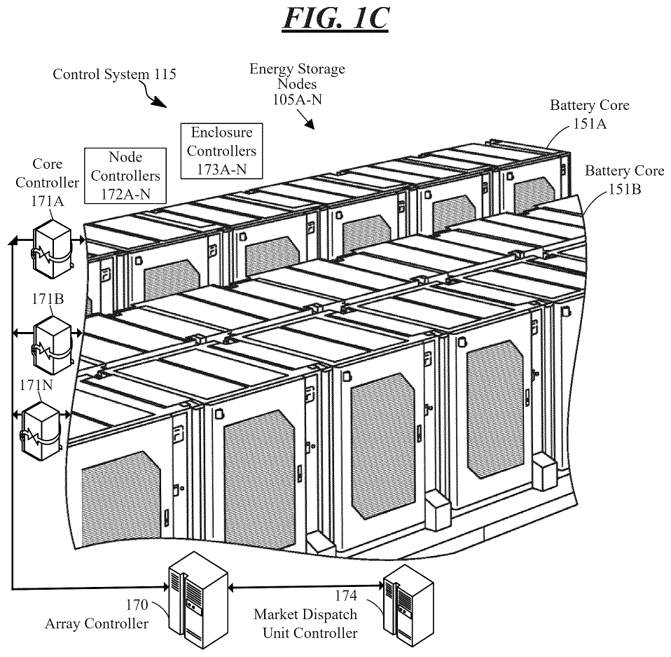

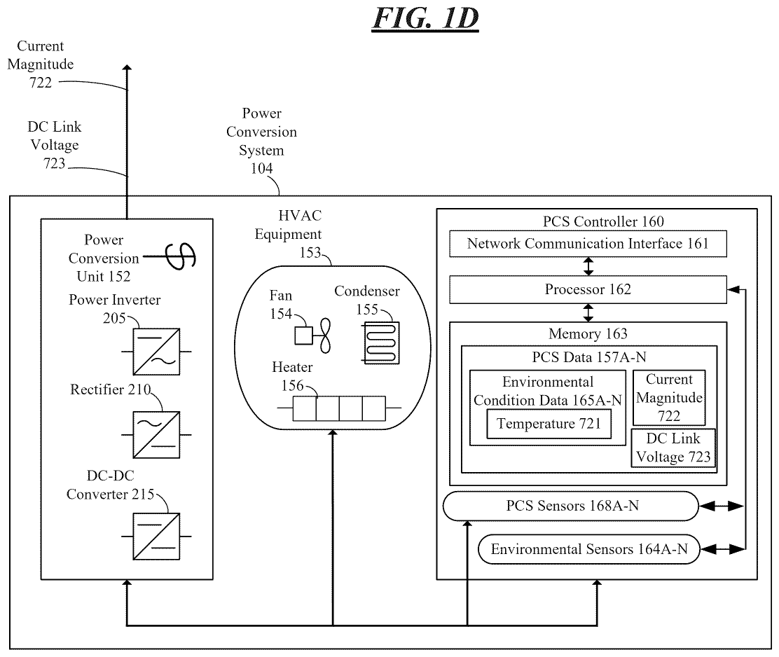

Unless otherwise indicated, any embodiment can be combined with any other embodiment. In particular, FIGS. 1A-9 and the associated text are all combinable with each other.

The term “coupled” as used herein refers to any logical, physical, electrical, or optical connection, link or the like by which electricity, power, signals, or light produced or supplied by one system element are imparted to another coupled element. Unless described otherwise, coupled elements or devices are not necessarily directly connected to one another and may be separated by intermediate components, elements, or communication media that may modify, manipulate or carry the electricity, power, signals, or light.

The orientations of the system 100, energy storage system 101, energy storage nodes 105A-N, associated components, and/or any complete devices, incorporating battery storage elements 106A-N, such as batteries, such as shown in any of the drawings, are given by way of example only, for illustration and discussion purposes. In operation for a particular energy storage application, an energy storage node 105A-N may be oriented in any other direction suitable to the particular application of the energy storage system 101, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system 101 or energy storage nodes 105A-N; or component of an energy storage system 101 or energy storage nodes 105A-N constructed as otherwise described herein.

Unless otherwise indicated, any coupled electrical components can be linked in series or in parallel. In the case of energy storage nodes 105A-N or battery storage elements 106A-N, the components may be linked in series, in parallel, or a combination thereof depending upon a state of a switch or a submodule.

Reference now is made in detail to the examples illustrated in the accompanying drawings and discussed below.

FIG. 1A depicts a system 100 that includes an energy storage system 101, energy system 102, and an electrical application 103. FIG. 1B depicts a battery array 150, an array controller 170, and core controllers 171A-N of an example architecture of a control system 115 of FIG. 1A.

Referring to both FIGS. 1A-B, for example, the energy storage system 101 can be a battery energy storage system (BESS). The energy storage system 101 is coupled to the energy system 102 and the electrical application 103. Energy storage system 101 can include one or more power conversion systems (PCSs) 104A-N, a plurality of energy storage nodes 105A-N, an optional transformer 108, and a control system 115. Components of the energy storage system 101 can be located at a physical space 120 that is outdoors or indoors, for example, inside of a building, a container, or other structure.

Energy storage system 101 comprises a battery array 150 including a plurality of battery cores 151A-N including a first set of battery cores 151A-C and a second set of battery cores 151D-F, for example. Each of the battery cores 151A-N include at least one power conversion system 104A-N. In an example, there can be one PCS 104 and one transformer 108 per battery core 151A-N (at the battery core level).

As described in further detail below, energy storage system 101 can include a control system 115 that includes one or more controllers 170-174, such as an array controller 170, core controllers 171A-N, node controllers 172A-N, enclosure controllers 173A-N, and a market dispatch unit controller 174. The control system 115 is configured to control the battery cores 151A-N to dispatch a required power flow 112.

Power conversion systems 104A-N are coupled to the plurality of energy storage nodes 105A-N. The power conversion systems 104A-N are coupled to the energy system 102 and the electrical application 103 to provide a required power flow 112 to the electrical application 103 by discharging the plurality of energy storage nodes 105A-N or the required power flow 112 from the energy system 102 for charging the plurality of energy storage nodes 105A-N. The power conversion systems 104A-N can be coupled to an optional transformer 108. The optional transformer 108 can step up or step down the required power flow 112 to and from the electrical application 103, such as an AC voltage.

Energy system 102 can include any suitable system for producing electrical energy from an energy source 109. Energy system 102 can be a renewable energy system in which the energy source 109 can be replenished. Such a renewable energy source 109 can include solar power, wind power, geothermal power, biomass, and hydroelectric power. For example, the renewable energy system 102 can be implemented as an array of photovoltaic modules. The photovoltaic (PV) modules can include crystalline silicon, amorphous silicon, copper indium gallium selenide (CIGS) thin film, cadmium telluride (CdTe) thin film, and concentrating photovoltaic which uses lenses and curved mirrors to focus sunlight onto small, but highly efficient, multi-junction solar cells. In another example, the energy system 102 can include wind turbines or gas turbines. In some examples, the energy system 102 can be a non-renewable energy system in which the energy source 109 includes a non-renewable energy source, such as a fossil fuel.

Electrical application 103 can include an electrical grid, such as a power grid, or a smaller local load, such as a backup power system, for a facility such as a hospital, manufacturing site, residential home, or other suitable facility. The electrical application 103 may deliver AC or DC power for on-grid or off-grid applications, including commercial, industrial, or residential applications. The electrical application 103 may deliver power to buildings, electric vehicle charging stations, etc., including a variety of electrical loads that consume AC or DC electric power. The electrical application 103 can be a front-of-the-meter system that is owned or operated by a utility company or a behind-the-meter system that directly supplies buildings and homes with electricity.

Energy source 109 can be a renewable energy source, such as solar power and wind power, which can be intermittent and less reliable compared to fossil fuels. To improve resiliency, energy storage system 101 can store energy from the energy system 102 when the production from the energy source 109 is high. Later on, the energy storage system 101 can dispatch the energy to the electrical application 103 when demand is high or production from the energy source 109 is not keeping up with demand. Moreover, events may occur when a connected load or an operating demand load of the electrical application 103 is excessive or there is electrical grid instability, such as during extreme weather. By storing energy from the energy source 109 and then dispatching the energy during such events, the energy storage system 101 can continue to dispatch a required power flow 112 of the electrical application 103.

Energy storage nodes 105A-N include battery storage elements 106A-N. The battery storage elements 106A-N can be: (1) a single battery cell; (2) a cell grouping, including several battery cells in parallel configuration; (3) a battery submodule or module, including several battery cells in parallel and serial configuration; (4) a battery string, including several battery modules in series; (5) a battery bank, including several battery strings in parallel; (6) other known energy storage elements; and/or (7) a combination thereof. For example, the battery storage elements 106A-N can include a plurality of batteries of any existing or future reusable battery technology, including, but not limited to lithium ion, flow batteries, or mechanical storage, such as flywheel energy storage, compressed air energy storage, pumped-storage hydroelectricity, gravitational potential energy, or a hydraulic accumulator.

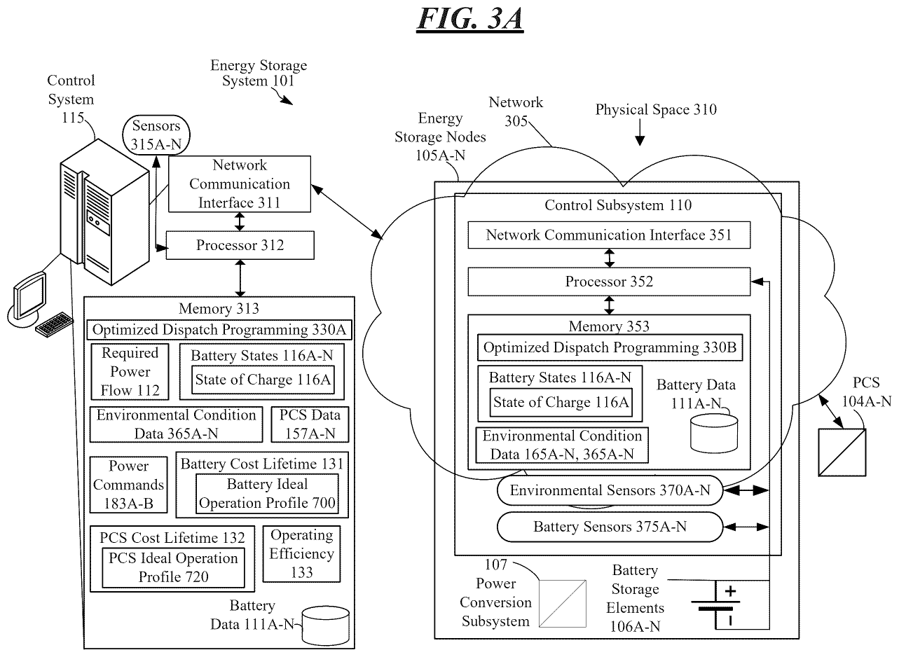

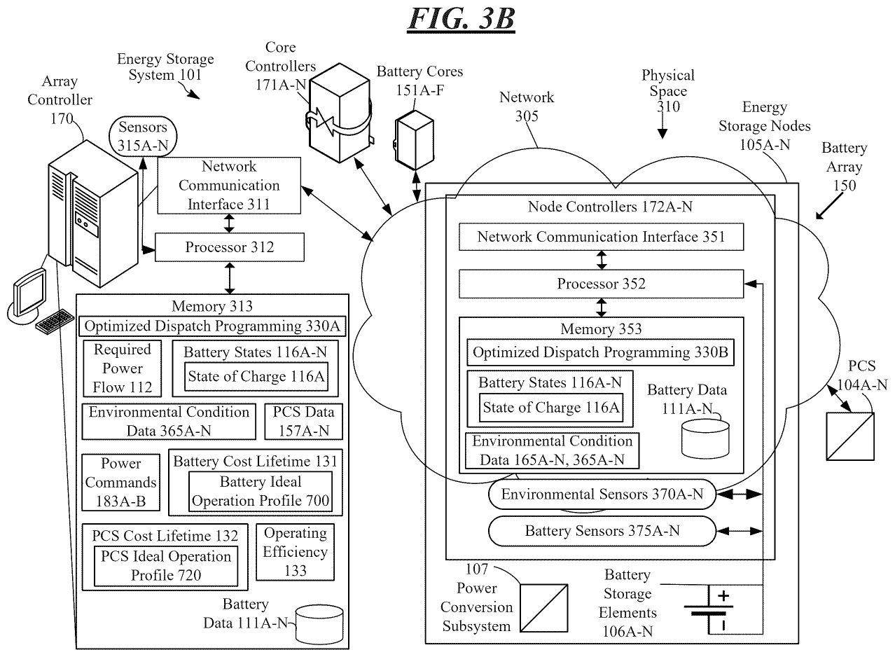

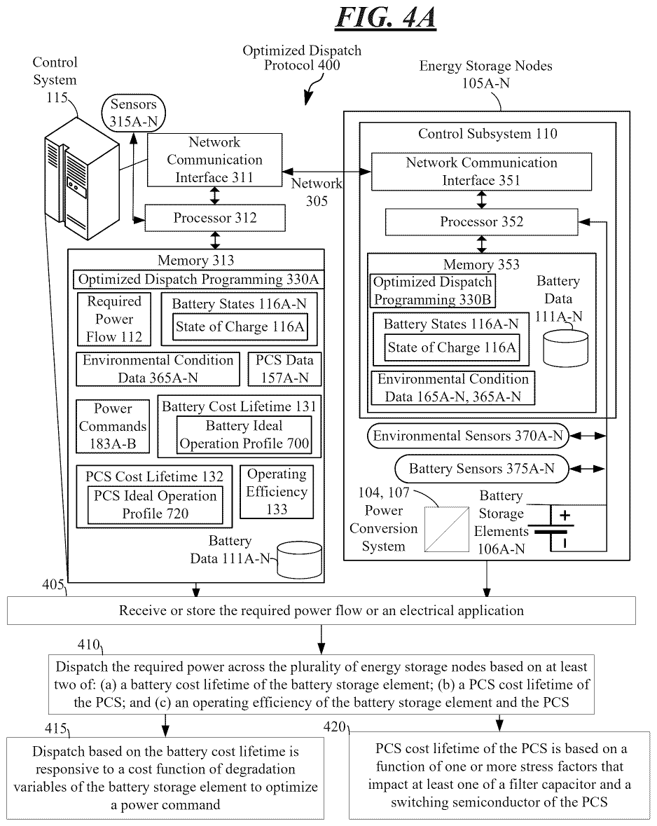

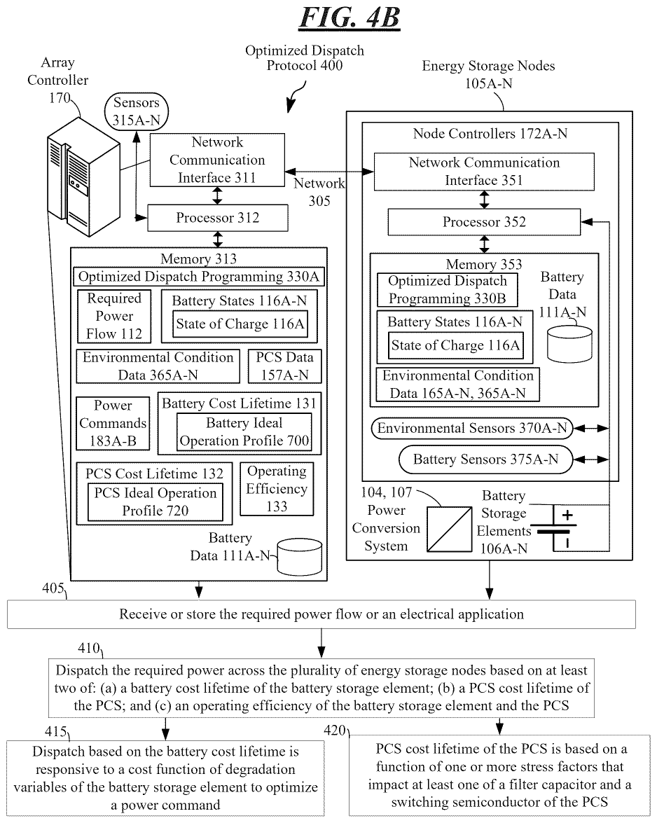

Control system 115 implements an optimized dispatch protocol 400 (see FIGS. 4A-B) which can be implemented in optimized dispatch programming 330A-B (see FIGS. 3A-B). Typically, an energy storage system 101 dispatches a required power flow 112 based on state of charge 116A of the energy storage nodes 105A-N only. The optimized dispatch protocol 400 dispatches the energy storage nodes 105A-N and PCSs 104A-N based on cost models to extend a lifetime of the energy storage system 101 by minimizing degradation of the battery storage elements 106A-N and PCSs 104A-B. The optimized dispatch protocol 400 determines the cost of next dispatch of an original power command 183 to maximize lifetime. For example, if the energy storage system 101 includes two energy storage nodes 105A-B only one energy storage node 105A may be dispatched instead of both energy storage nodes 105A-B if the original power command 183 is still satisfied to maximize lifetime of the equipment.

FIG. 1C depicts the array controller 170, the core controllers 171A-N, node controllers 172A-N, and enclosure controllers 173A-N in the example architecture of the control system 115 of FIGS. 1A-B. In the example, each of the energy storage nodes 105A-N can be a collection of one or more battery cubes 230A-N and every battery cube 230A-N includes an enclosure controller 173. A node controller 172 is the lowest controllable element of a battery core 151 for an energy storage node 105A-N and controls an individual energy storage node 105. A core controller 171 is the next higher level, which controls a subset of the energy storage nodes 105A-N, where each core represents branches of components of the energy storage system 101. The core controller 171 is a logical controller and can represent a transformer 108 that stands between the PCS 104 and the rest of the plant. Core controller 171 is an aggregator of different node controllers 172A-N and propagates the commands from the array controller 170 to the node controllers 172A-N.

Array controller 170 is higher than the core controllers 171A-N and controls the overall energy storage system 101. The software for the array controller level can be installed at a customer installation site and can execute at the installation site. The array controller 170 can be a local decentralized service that runs onsite in real time.

A market dispatch unit controller 174 is a network wide controller and sits on top of the array controller 170 and looks at specific market requirements. The market dispatch unit controller 174 sets dispatch setpoints in terms of active and reactive power to the array controller 170 which deals with the energy storage system 101.

A battery core 151 can have multiple node controllers 172A-N depending on the number of energy storage nodes 105A-N and bus architecture of the battery core 151. In an example, if the PCS 104 is used as a single bus element, then there may be only one node controller 172 behind a core controller 171 for a single energy storage node 105A and only one PCS 104 per energy storage node 105A. But if the PCS 104 is used with multiple DC connections in a split bus architecture where a plurality of energy storage nodes 105A-D (e.g., four) are connected to the bus, there can be a plurality of energy storage nodes 105A-D on the bus and only one PCS 104 for all of the plurality of energy storage nodes 105A-D.

FIG. 1D depicts a power conversion system 104 of a battery core 151 of FIGS. 1A-C. As shown, the power conversion system 104 can include a power conversion unit 152, which can include a power inverter 205, rectifier 210, DC-DC converter 215, etc., or a combination thereof. The power conversion unit 152 can be an insulated-gate bipolar transistor (IGBT) module that is part of the PCS 104. The IGBT module can include an array of transistors (e.g., switching semiconductors), capacitors (e.g., filter capacitors), and any other power electronic devices to convert power. On one side of the power conversion unit 152 can be AC current and the other side DC current. The IGBT module is standard, but a variety of architectures can be used.

Power conversion system 104 further includes a heating, ventilation, and air conditioning (HVAC) equipment 153 to maintain the temperature of equipment of the PCS 104, such as the power conversion unit 152, within operating limits. The HVAC equipment 153 can include an air conditioner, such as a fan 154 and a condenser 155 to cool down the power conversion unit 152 (e.g., IGBT module). The HVAC equipment 153 can further include a heater 156.

The power conversion system 104 further includes a PCS controller 160 and environmental sensors 164A-N to protect the equipment of the PCS 104. As shown, the PCS controller 160 includes a network communication interface 161, a processor 162, and a memory 163. The PCS 104 further includes PCS sensors 168A-N to measure a current magnitude 722 and a DC link voltage 723. The environmental sensors 164A-N are coupled to the processor 163 and can collect environmental condition data 165A-N, for example, by measuring temperature 165A, 721 and humidity 165B inside of an enclosure of the PCS 104. The memory 163 can store the PCS data 157A-N, including the environmental condition data 165A-N, temperature 721 collected by the environmental sensors 164A-N and a current magnitude 722 and a DC link voltage 723 collected by PCS sensors 168A-N. The PCS data 157A-N, including the environmental condition data 165A-N, such as temperature 165A, 721; and current magnitude 722 and DC link voltage 723 are monitored during the optimized dispatch protocol 400 (see FIGS. 4A-B) and acted upon to make decisions when to run the PCS 104.

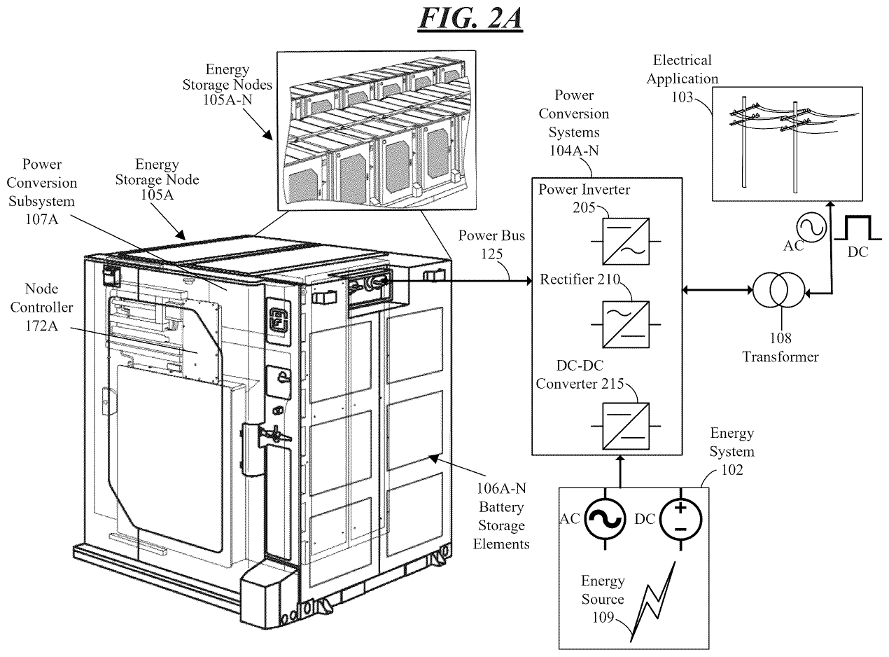

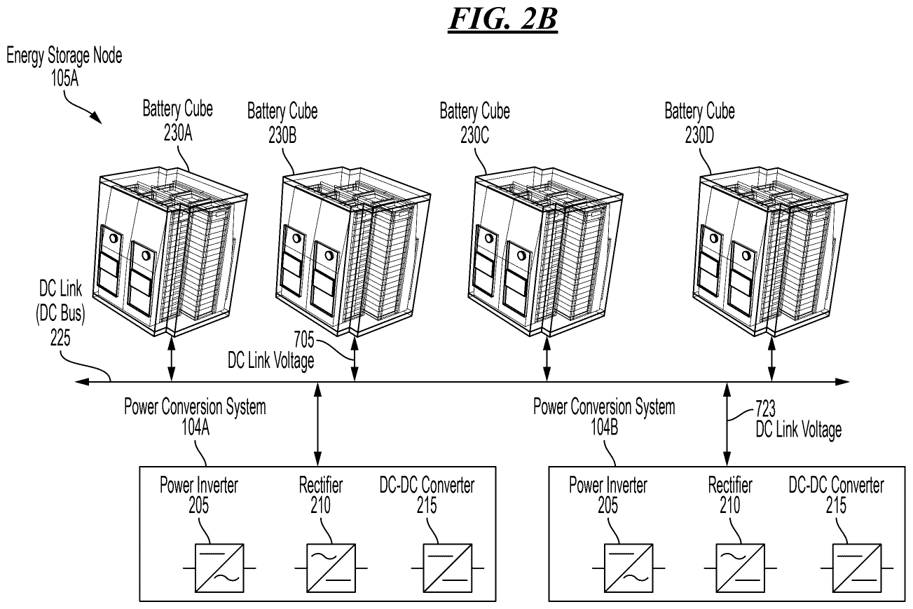

FIG. 2A illustrates a first energy storage node 105A of the plurality of energy storage nodes 105A-N of FIGS. 1A-C coupled to the electrical application 103. The first energy storage node 105A can include a single battery cube 230A (as in the case of FIG. 2A) or a plurality of battery cubes 230A-D (as in the case of FIG. 2B). Energy storage nodes 105A-N can include a battery storage element 106, a power conversion system 104 (or a power conversion subsystem 107), and a node controller 172 (or a control subsystem 110) to receive battery data 111A-N from the battery storage element 106, PCS data 157A-N from the power conversion system 104 (or the power conversion subsystem 107), or a combination thereof.

Power conversion system 104 (or the power conversion subsystem 107) can include a power inverter 205, a rectifier 210, a DC-DC converter 215, other power conversion elements, or a combination thereof. Power inverter 205 can be configured to convert a DC source, such as from the battery storage elements 106A-N, into an AC waveform. Rectifier 210 can be configured to convert an AC source, such as from the energy system 102 or electrical application 103, into DC for the battery storage elements 106A-N. DC-DC converter 215 can be configured to convert a DC source, such as from the battery storage elements 106A-N, into a different DC source characteristic.

If the energy source 109 is wind power, then the power conversion system 104 can convert the AC electricity produced into DC power for storage in the plurality of energy storage nodes 105A-N via the rectifier 210. If the energy source 109 is solar power, then the power conversion system 104 can convert the DC electricity into a different voltage level via the DC-DC converter 215. The power inverter 205 can convert the required power flow 112 from the energy storage system 101 from DC power into AC power during dispatch to the electrical application 103. For example, the power inverter 205 can be configured to convert power on a power bus 125 (e.g., AC bus, DC bus, or both) for use by the electrical application 103. For example, the power inverter 205 converts DC power stored in the energy storage nodes 105A-N into AC power for consumption by electrical loads of the electrical application 103.

Power conversion subsystem 107 includes similar hardware and software as the more centralized power conversion system 104. Power conversion subsystem 107 can be distributed more locally to each of energy storage nodes 105A-N. The node controller 172 and the control subsystem 110 can be configured for local computation, processing, and control of the battery storage elements 106A-N and the power conversion subsystem 107. The control system 115 and the array controller 170 can be configured for more centralized computation, processing, and controls of the overall energy storage system 101, energy system 102, electrical application 103, and power conversion system 104. The various controllers 170-173 of the control system 115, including the array controller 170, core controllers 171A-N, node controllers 172A-N, and enclosure controllers 173A-N can include a single board computer, an application-specific integrated circuit (ASIC), microcontroller, digital signal processor (DSP), field-programmable gate array (FPGA), or a combination thereof.

FIG. 2B illustrates a first energy storage node 105A that includes a plurality of battery cubes 230A-N and a plurality of power conversion systems 104A-N coupled to a DC link (DC bus) 225. As shown, the first energy storage node 105A includes four battery cubes 230A-D and two power conversion systems 104A-B coupled to the DC link (DC bus) 225 in the example. The first energy storage node 105A can be arranged so the battery cubes 230A-B are connected to a DC bus 225A with the PCS 104A in a split bus architecture. Battery cubes 230C-D can be connected to a DC bus 225B with the PCS 104B also in a split bus architecture. Battery sensors 375A-N can measure a DC link voltage 705 of the battery cube 230B on the DC bus 225A. PCS sensors 168A-N can measure a DC link voltage 723 of the PCS 104B on the DC bus 225B.

FIG. 3A is a high-level functional block diagram of the energy storage system 101 of FIG. 1A that depicts components of the control system 115 and the control subsystem 110 for optimized dispatch of the energy storage nodes 105A-N. FIG. 3B is another high-level functional block diagram of the energy storage system of FIGS. 1B-C that depicts components of the control system 115 with various controllers 170-173 for optimized dispatch of the energy storage nodes 105A-N.

Referring to FIGS. 3A-B, as shown, the plurality of energy storage nodes 105A-N include a battery storage element 106A-N; a power subsystem 107; and a control subsystem 110 (FIG. 3A) or a node controller 172 (FIG. 3B) to receive battery data 111A-N from the battery storage element 106A-N, PCS data 157A-N from the power conversion subsystem 107, or a combination thereof. The control system 115 can be coupled to the energy storage nodes 105A-N and the PCS 104 and configured to receive battery data 111A-N from the battery storage element 106, PCS data 157A-N from the power conversion system 104, or a combination thereof.

The control subsystem 110; control system 115, including the array controller 170, core controllers 171A-N, node controllers 172A-N, and enclosure controllers 173A-N; energy storage nodes 105A-N; electrical application 103; and other components of the system 100 can be in communication over a network 305 or one or more networks 305A-N. The networks 305A-N can be a local area network 305A, wide area network 305B, or a combination thereof. For example, the control system 115 can be coupled via a local area network 305A to the energy storage nodes 105A-N and the electrical application 103. Alternative or additionally, the control system 115 can be coupled via a wide area network 305B to the energy storage nodes 105A-N and electrical application 103. Or the control system 115 can be coupled via a combination of networks 305A-N, such as via a local area network 305A to components of the energy storage system 101, including the energy storage nodes 105A-N, and coupled via a wide area network 305B to the electrical application 103.

Control system 115 of FIG. 3A and array controller 170 of FIG. 3B include a network communication interface 311 configured for wired or wireless communication over the network 305. The control system 115 and the array controller 170 further include a memory 313, and a processor 312 coupled to the network communication interface 311 and the memory 313. As shown, the memory 313 of the control system 115 and the array controller 170 is configured to store optimized dispatch programming 330A; battery data 111A-N; a required power flow 112; battery states 116A-N (including a state of charge 116A); environmental condition data 365A-N from the energy storage nodes 105A-N; PCS data 157A-N (including the environmental condition data 165A-N from the PCSs 104A-N); power commands 183A-B, a battery cost lifetime 131 (including a battery ideal operation profile 700); a PCS cost lifetime 132 (including a PCS ideal operation profile 720); and an operating efficiency 133. The control system 115 and the array controller 170 can also include sensors 315A-N coupled to the processor 312 to detect or monitor various system parameters, such as power, temperature, voltage, current, resistance, and/or impedance. For example, the sensors 315A-N, battery sensors 375A-N can be coupled to the power bus 125 and the DC link (DC bus) 225.

Control system 115 and the array controller 170 are configured to receive or store a required power flow 112 or a power capacity for an electrical application 103. The required power flow 112 can include an active power (e.g., measured in kW or mW), a reactive power (e.g., measured in kVARs), or a total system power discharge or charge requirement. The required power flow 112 can be a power command 183 for the electrical application 103 based on a customer or independent system operator request received over the network 305 from the electrical application 103, in which case the power command 183 is externally determined. The power capacity can be apparent power (e.g., kVA or MVA), such as name plate capacity measured in volt-amperes that can be used for power electronics or electronic equipment to define capabilities in terms of overall power. Both active power and reactive power come together to form apparent power and manufacturers define the capability of the power capacity of power electronics equipment based on the apparent power.

The power command 183 for the electrical application 103 can be based on parameters in a customer or independent system operator request received over the network 305 from the electrical application 103. For example, the parameters can be to provide frequency regulation with a deadband and a slope of the response. The control system 115 can take the parameters and attempt to determine the power command 183, for example, based on satisfying the customer or independent system operator request for the electrical application 103.

Control system 115 can take the required power flow 112 needed for the electrical application 103, for example, as requested by a customer or software application and determine the optimal way to distribute the required power flow 112 across all of the energy storage nodes 105A-N. This optimization may be conducted in several manners, for example using traditional operational optimization techniques or machine-learning based techniques. The control system 115 can include one or more processors, controllers, or computing devices that can be configured to perform closed loop management of real and reactive power supplied to the electrical application 103.

Energy storage nodes 105A-N include a control subsystem 110 in FIG. 3A and a node controller 172 in FIG. 3B, battery storage elements 106A-N, and a power conversion subsystem 107 (or a power conversion system 104), which can reside on each individual energy storage node 105A-N. The control subsystem 110 and the node controller 172 of the energy storage nodes 105A-N include a network communication interface 351 configured for wired or wireless communication over the network 305. The control subsystem 110 and the node controller 172 further include a memory 353, and a processor 352 coupled to the network communication interface 351 and the memory 353. As shown, the memory 353 of the control subsystem 110 and the node controller 172 is configured to store optimized dispatch programming 330B, battery data 111A-N, battery states 116A-N (including a state of charge 116A), and environmental condition data 165A-N, 365A-N.

The control subsystem 110 and the node controller 172 further include environmental sensors 370A-N and battery sensors 375A-N coupled to the processor 352. Environmental sensors 370A-N can collect environmental condition data 365A-N, for example, by measuring humidity and temperature inside of an enclosure 500 of the energy storage nodes 105A-N, such as one or more battery cubes 230A-N. Battery sensors 375A-N can include a voltage sensor 375A, a current sensor 375B, and a temperature sensor 375C to measure readings of battery data 111A-N, such as a voltage 111A, a current 111B, a temperature 111C, or other physical phenomena occurring within the battery storage elements 106A-N. The memory 353 can store the environmental condition data 365A-N collected by the environmental sensors 370A-N and the battery data 111A-N measured by the battery sensors 375A-N.

The control subsystem 110 or the control system 115 is configured to determine at least one battery state 116A-N about one or more of the energy storage nodes 105A-N from the battery data 111A-N. The battery states 116A-N can be algorithmically determined estimates from battery data 111A-N, readings from the sensors 315A-N, battery sensors 375A-N that monitor various system parameters on the power bus 125, DC link (DC bus) 225, or a combination thereof, for example. State estimating algorithms can take the measured readings of battery data 111A-N, including the voltage 111A, the current 111B, the temperature 111C, or a combination thereof as input parameters and estimate the battery states 116A-N based on the battery data 111A-N.

For example, a state of charge 116A is a state estimate derived from the voltage 111A and the current 111B readings. The state of charge 116A can be derived from the control system 115. Alternatively or additionally, at least one battery management system (BMS) or the node controller 172 can derive the state of charge 116A. The state of charge 116A can be determined for a first energy storage node 105A that includes a plurality of battery cubes 230A-N. The control subsystem 110 can include at least one battery management systems (BMS). For example, the SOC 116A can be determined for an entire energy storage node 105A-N (e.g., a first energy storage node 105A including all seven battery cubes 230A-G of all battery storage elements 106A-N behind the first energy storage node 105A). SOC calculations may look at voltage on the DC bus 225 over time. The SOC 116A is a calculated number of all battery cubes 230A-G put together on that first energy storage node 105A based on how much current is being put through and how much energy can get out. The SOC 116A can be one parameter reading for an entire DC bus 225 for the first energy storage node 105A.

The SOC 116A provided by a battery management system, for example, can be based on Coulombe counting and be a number from 0-100% as to whether a first energy storage node 105A is full or empty. Typically, the SOC 116A is provided at the node level for all of the battery cubes 230A-N on that DC bus 225. Each battery rack of a battery cube 230 has a BMS and that information can be propagated to a system level BMS to determine the SOC 116A of all of the battery cubes 230A-N, as opposed to each individual battery cube 230 or each battery cell in the battery cube 230.

The control system 115 and the array controller 170 can manage power commands 183A-N to the control subsystem 110 and the node controller 172 respectively, to charge or discharge the plurality of energy storage nodes 105A-N based on the required power flow 112. For example, the control system 115 and the array controller 170 can send the power commands 183A-N based on the total required power flow 112 to the plurality of energy storage nodes 105A-N. Alternatively or additionally, the control subsystem 110 and the node controller 172 can issue the power commands 183A-N directly at the plurality of energy storage nodes 105A-N based on the required power flow 112.

FIG. 4A is an optimized dispatch protocol 400 for the energy storage system 101 of FIG. 1A that is implemented by the control system 115, the control subsystem 110, and the and the plurality of energy storage nodes 105A-N. In the example of FIG. 4A, the optimized dispatch protocol 400 is implemented in the optimized dispatch programming 330A of the control system 115 and the optimized dispatch programming 330B of the control subsystem 110.

FIG. 4B is the optimized dispatch protocol 400 for the energy storage system 101 of FIGS. 1B-C that is implemented by the various controllers 170-173 of the control system 115 and the plurality of energy storage nodes 105A-N. In the example of FIG. 4B, the optimized dispatch protocol 400 is implemented in the optimized dispatch programming 330A of the array controller 170 and the optimized dispatch programming 330B of the node controller 172.

Referring to both FIGS. 4A-B, execution of optimized dispatch programming 330A stored in a memory 313 by a processor 312 of the control system 115 (e.g., array controller 170) configures the control system 115 (e.g., array controller 170) to implement blocks 405, 410, 415, and 420 described below. Execution of optimized dispatch programming 330B stored in a memory 353 by a processor 352 of the control subsystem 110 (e.g., node controller 172) can configure the control subsystem 110 (e.g., node controller 172) to implement some portion or all of blocks 405, 410, 415, and 420 described below. More generally, the execution of the optimized dispatch programming 330A-B by one or more processors 312, 352 can configure one or more controllers 110, 115, 170-173 to implement blocks 405, 410, 415, and 420 below.

Beginning in block 405, the optimized dispatch protocol 400 includes to receive or store the required power flow 112 for an electrical application 103. For example, the energy storage system 101 can dispatch a power command 183 every 50-100 milliseconds from the electrical application 103 to the control system 115 (or array controller 170).

Moving now to block 410, the optimized dispatch protocol 400 further includes to dispatch the required power flow 112 across the plurality of energy storage nodes 105A-N based on at least two of: (a) a battery cost lifetime 131 of the battery storage element 106; (b) a PCS cost lifetime 132 of the PCS 104; and (c) an operating efficiency 133 of the battery storage element 106 and the PCS 104. The operating efficiency 133 can be based on a function to maximize an efficiency curve of the PCS 104 and the battery storage element 106. The efficiency curve is a data chart typically provided by a manufacturer of the battery storage elements 106A-N and PCSs 104A-N. The optimized dispatch protocol 400 dispatches based on cost of degradation to extend the lifetime of the equipment of the energy storage system 101, such as the battery storage elements 106A-N and PCSs 104A-N.

In an example, some of the energy storage nodes 105A-D may include newer battery storage elements 106A-D that were replaced recently compared to energy storage nodes 105E-H that have older battery storage elements 106E-H. Based on the battery cost lifetime 131, the control system 101 may dispatch energy storage nodes 105A-D instead of energy storage nodes 105E-H. Or if energy storage nodes 105H-L are hot compared to energy storage nodes 105A-G, then the control system 115 may not dispatch energy storage nodes 105H-L until they are cooler. Typically, a power command 183 for the required power flow 112 does not request full power, for example, the request may be for ten, twenty-five, or fifty percent of the power stored in the energy storage system 101. If the control system 115 can satisfy the power command 183 with four energy storage nodes 105A-D instead of ten energy storage nodes 105A-J to extend lifetime, then optimized power commands 183A-N can be generated by the control system 115.

If energy storage nodes 105A-N are selected in the dispatch of the required power flow 112 that have degradation variables 701-705 within minimum and maximum ranges 707, 708 of the battery ideal operation profile 700; and PCSs 104A-N are selected that have stress factors 721-723 within minimum and maximum ranges 726, 727 of the PCS ideal operation profile 720, then over time a lifetime of the entire energy storage system 101 can be extended. For example, less heat loss from the battery storage elements 106A-N and PCSs 104A-N can improve efficiency. Battery storage elements 106A-N are often the most expensive components of the energy storage system 101 and so optimizing the lifetime of this component enables more value to be captured by a customer. Additionally, when the state of charge 116A of battery storage elements 106A-N is very empty or full, the battery storage elements 106A-N are not efficient to operate. If battery storage elements 106A-N are selected within range of the state of charge 703A-B of the battery ideal operation profile 700, then high efficiency and less loss is obtained in the energy storage system 101. The best model for efficiency is when the curves for the battery storage elements 106A-N and PCSs 104A-N lineup in which case 98-99% round trip efficiency from the energy storage nodes 105A-N and PCSs 104A-N may be attainable.

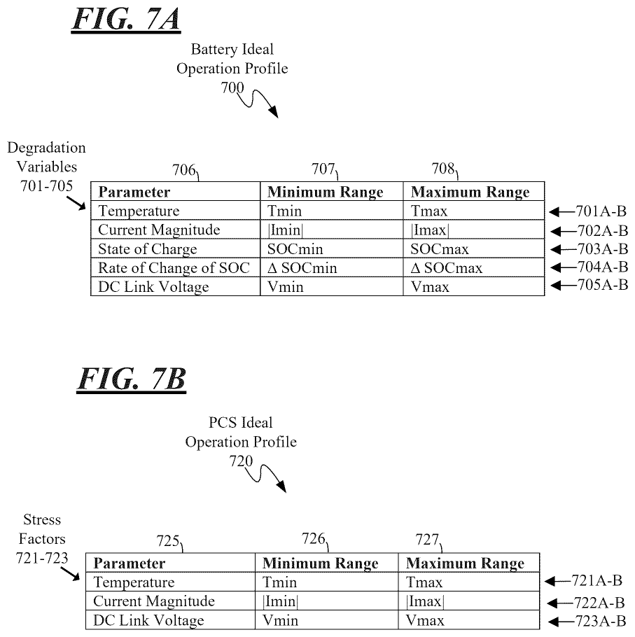

Continuing to block 415 and with reference to FIG. 7A, the dispatch based on the battery cost lifetime 131 can be based on a battery ideal operation profile 700 derived from research-based battery models or experimental data. The battery ideal operation profile 700 includes at least one of a minimum range and a maximum range of a temperature 701A-B, a current magnitude 702A-B, a state of charge (SOC) 703A-B, a rate of change of SOC 704A-B, and a DC link voltage 705A-B. Hence, as shown in block 415, the dispatch based on the battery cost lifetime 131 can be responsive to a cost function of degradation variables 701-705 of the battery storage element 106 to optimize a power command 183.

Optimized dispatch protocol 400 dispatches the equipment, including the energy storage nodes 105A-N and PCSs 104A-N in the most efficient way and moves around as the efficiency of the equipment changes. For example, if the energy storage system 101 includes four energy storage nodes 105A-N instead of allocating one-quarter of the power command 183 to each, the optimized dispatch may assign 50% to a first energy storage node 105A, 10% to a second energy storage node 105B, and 40% to a third energy storage node 105C. The optimized dispatch protocol 400 monitors the battery storage elements 106A-N of the energy storage nodes 105A-N and the PCSs 104A-N and understands how the usage degrades the battery storage elements 106A-N and the PCSs 104A-N. For example, if the battery storage elements 106A-N need to be replaced every ten years and the PCSs 104A-N need to be replaced every five years, the optimized dispatch protocol 400 can slow down the degradation by using that equipment in a more efficient manner.

Finishing now in block 420 with reference to FIG. 7B, the PCS cost lifetime 132 of the PCS 104 can be based on a function of one or more stress factors 721-723 that impact at least one of a filter capacitor and a switching semiconductor (or a power conversion unit 152) of the PCS 104. The PCS cost lifetime 132 can be based on a PCS ideal operation profile 720 derived from research-based PCS models or experimental data. The PCS ideal operation profile 720 includes at least one of a minimum range and a maximum range of a temperature 721A-B, a current magnitude 722A-B, and a DC link voltage 723A-B.

In FIG. 4A, the local control subsystem 110 or the control system 115 can implement a subset or all of the blocks 405, 410, 415, and 420 of the optimized dispatch protocol 400 without the central control system 115. For example, the required power flow 112 can be stored or received by the control system 115 or one, a subset, or all of the control subsystem(s) 110 of the energy storage nodes 105A-N from the electrical application 103 over the network 305. The control subsystem 110 of the energy storage nodes 105A-N that receives the required power flow 112 can then implement blocks 410, 415, and 420.

In FIG. 4B, the core controllers 171A-N, node controllers 172A-N, and enclosure controllers 173A-N can implement a subset or all of the blocks 405, 410, 415, and 420 of the optimized dispatch protocol 400 without the central array controller 170. For example, the required power flow 112 can be stored or received by one, a subset, or all of the core controllers 171A-N, and node controllers 172A-N of the energy storage nodes 105A-N, and enclosure controllers 173A-N from the electrical application 103 over the network 305. The optimized dispatch programming 330A may be stored and executed on the core controllers 171A-N and enclosure controllers 173A-N.

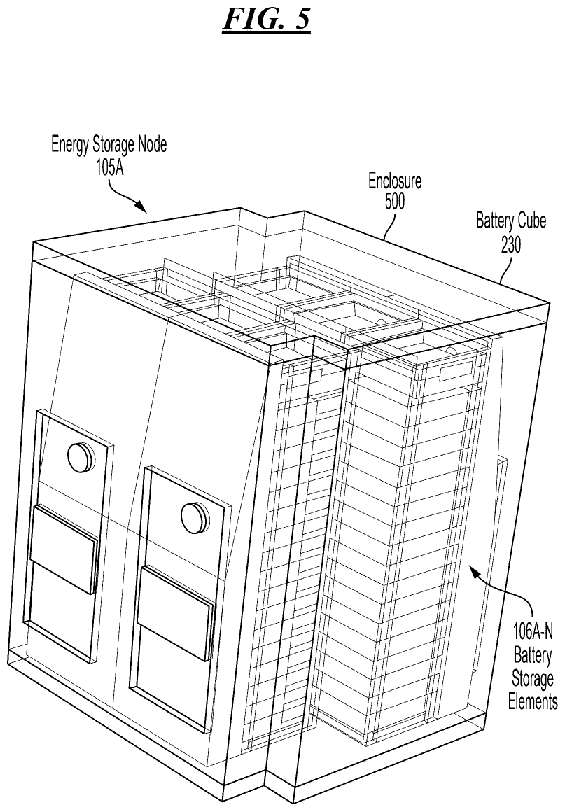

FIG. 5 is a cutaway view of the first energy storage node 105A of the plurality of energy storage nodes 105A-N and shows details of a plurality of battery storage elements 106A-N. As shown, the energy storage node 105A includes an enclosure 500, such as a physical housing to store a plurality of battery storage elements 106A-N. The battery storage elements 106A-N can be a collection of one or more batteries, such as a plurality of battery strings or battery banks, which are organized logically, physically, and electrically.

In the example of FIG. 5, the battery storage elements 106A-N can include battery racks (e.g., six are shown) that hold a respective stack of battery modules (e.g., seventeen are shown). The battery modules can include an array of prismatic, pouch, or cylindrical battery cells that are packaged together to increase voltage, amperage, or both. In some examples, battery modules may include an electric vehicle battery pack, e.g., a collection of lithium-ion battery cells that are packaged together.

Each of the energy storage nodes 105A-N can include a collection of one or more enclosures 500A-N like that shown in FIG. 5 that house a plurality of battery storage elements 106A-N packaged together as a battery cube 230 in the example. Of course, the enclosure 500 can be shaped in a variety of other form factors. Each of the battery cubes 230A-N can further include a respective enclosure controller 173A-N that is controlled by a respective node controller 172A-N as part of the control system 115.

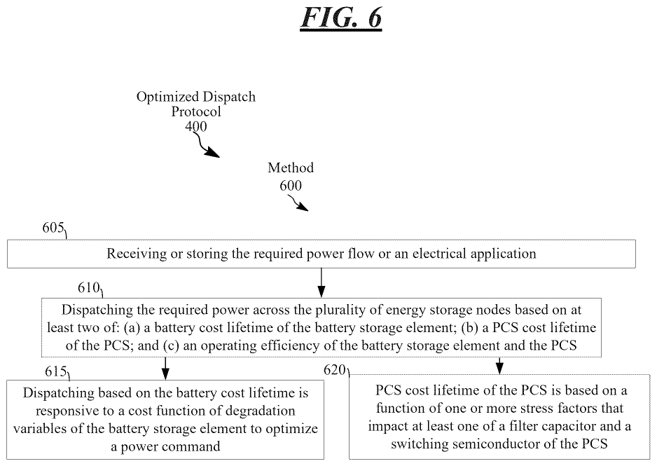

FIG. 6 is a flowchart of a method 600 that can be implemented for optimized dispatch of the energy storage system 100. In the example of FIG. 6, the method 600 implements the optimized dispatch protocol 400 of FIG. 4. Beginning in step 605, the method 600 includes receiving or storing a required power flow 112 for an electrical application 103.

Continuing to step 610, the method 600 further includes dispatching the required power flow 112 across a plurality of energy storage nodes 105A-N based on at least two of: (a) a battery cost lifetime 131 of a battery storage element 106; (b) a power conversion system cost lifetime 132 of a power conversion system (PCS) 104; and (c) an operating efficiency 133 of the battery storage element 106 and the PCS 104.

Moving now to step 615 with reference to FIG. 7A, the dispatching based on the battery cost lifetime 131 can be based on a battery ideal operation profile 700 derived from research-based battery models or experimental data.

Finishing now in step 620, the PCS cost lifetime 132 of the PCS can be 104 based on a function of one or more stress factors 721-723 that impact at least one of a filter capacitor and a switching semiconductor of the PCS 104.

The optimized dispatch protocol 400 implemented in the optimized dispatch programming 330A-B issues optimized power commands 183A-N to the energy storage nodes 105A-N and PCSs 104A-N which degrade the equipment the least and yet meet the power requirements, such as the required power flow 112. In most cases, the original power command 183 does not require a full power discharge or charge from the energy storage system 101, meaning the entire power stored in the energy storage system 101 is not needed for dispatch. For example, an original power command 183 may require only fifty percent of the power stored. The optimized power commands 183A-N generated by the optimized dispatch protocol 400 may only use twenty-five percent of the equipment instead of all of the equipment at 50% provided the equipment degradation is less and extends lifetime of the energy storage system 101. If the power command 183 requires full power, then all of the equipment is needed to satisfy the required power flow 112 and a dispatch with greater efficiency is not attainable.

FIG. 7A is a battery ideal operation profile 700. The battery ideal operation profile 700 can be derived from research-based battery models or experimental data. The battery ideal operation profile 700 includes at least one of a minimum range and a maximum range of a temperature 701A-B, a current magnitude 702A-B, a state of charge (SOC) 703A-B, a rate of change of SOC 704A-B, and a DC link voltage 705A-B.

FIG. 7B is a PCS ideal operation profile 720. The PCS ideal operation profile 720 can be derived from research-based PCS models or experimental data. The PCS ideal operation profile 720 includes one or more stress factors 721-723 that impact at least one of a filter capacitor and a switching semiconductor (or a power conversion unit 152). For example, the PCS ideal operation profile 720 includes at least one of a minimum range and a maximum range of a temperature 721A-B, a current magnitude 722A-B, and a DC link voltage 723A-B.

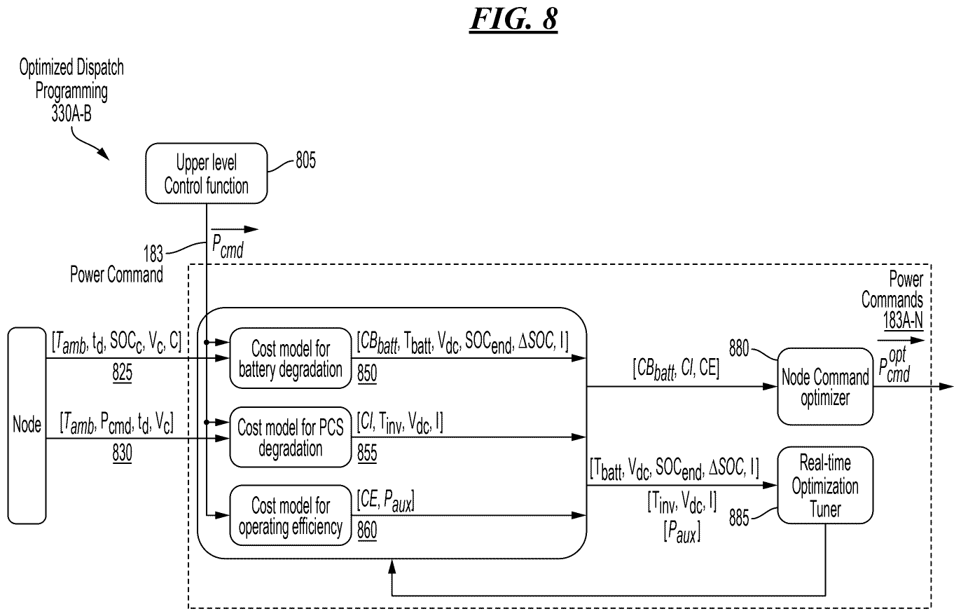

FIG. 8 is a block diagram of the optimized dispatch protocol 400 implemented in the optimized dispatch programming 330A-B. The optimized dispatch programming 330A-B can include a BESS Lifetime and Efficiency Optimizing Intelligent Module (BLIM) which implements the depicted control command flow and upper level functions of FIG. 8. The BLIM can be implemented in the optimized dispatch protocol 400 described herein. Beginning block 805, an upper level control function of the optimized dispatch programming 330A-B is initiated.

Moving to block 825, battery data 111A-N and battery states 111A-N are provided from the energy storage nodes 105A-N via sensors 315A-N, battery sensors 375A-N to a cost model for battery degradation block 850. Environmental condition data 365A-N is also provided from the energy storage nodes 105A-N via environmental sensors 370A-N to the cost model for battery degradation block 850. For example, ambient temperature (T_{amb}) 365A, t_{d}, state of charge (SOC_{c}) 116A, voltage (V_{c}) 111A, and current (C) 111B, are provided from the energy storage nodes 105A-N to the cost model for battery degradation block 850.

Cost model for battery degradation block 850 outputs a degradation cost CB_{batt}, a temperature of battery T_{batt} 701, a current magnitude I 702, an SOC at the end of command SOC_{end} 703, a rate of change of SOC ΔSOC 704, and a DC link voltage V_{dc} 705. A battery cost lifetime 131 cost function (CB_{batt}) is implemented in the cost model for battery degradation block 850.

Proceeding to block 830, PCS data 157A-N is provided from the power conversion systems 104A-N via PCS sensors 168A-N to a cost model for PCS degradation block 855. Environmental condition data 165A-N is also provided from the power conversion systems 104A-N via environmental sensors 164A-N to the cost model for PCS degradation block 855. The PCS cost lifetime 132 is implemented in the cost model for PCS degradation block 855. For example, an ambient temperature (T_{amb}) 165A, power commands 183A-B, t_{d}, and a voltage (V_{c}) 157A are provided from the PCSs 104A-N to the cost model for PCS degradation block 855.

In block 855, the cost model for PCS degradation block outputs a degradation cost CI, a temperature of the PCS inverter Tiny 721, a current (I) 722, and a DC link voltage V_{dc} 723, which is directly related to power commands 183A-B (P_{cmd}). The operating efficiency 133 is implemented in a cost model for operating efficiency block 860. The cost model for operating efficiency block 860 outputs a cost of efficiency CE and an auxiliary power Pₐᵤₓ. The auxiliary power can be energy consumed by the energy storage system 101, including heating, ventilation, and air conditioning (HVAC) equipment to maintain the batteries 106A-N and power conversion systems 104A-N at a suitable temperature; and keep the associated components energized and connected to a power bus 125 or a DC link (DC bus) 225.

Proceeding to block 880, the command optimization of BLIM is performed (node command optimizer). As shown, the node command optimizer is based on at least two of three cost functions: (1) a battery cost lifetime 131 cost function (CB_{batt}) (cost model for battery degradation block); (2) a PCS cost lifetime 132 function (CI) (cost model for PCS degradation block); and (3) an operating efficiency 133 cost function (CE) (cost model for operating efficiency block).

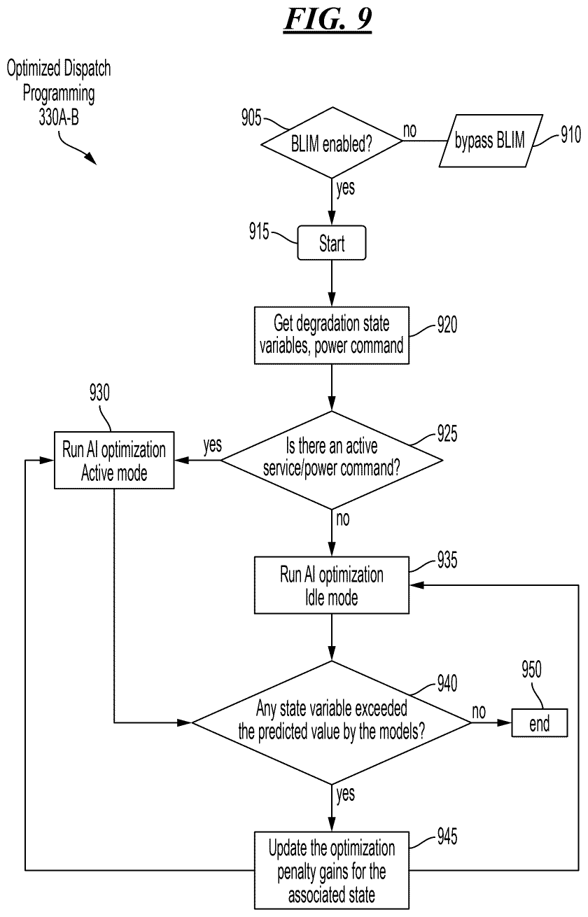

Node command optimizer block 880 solves the optimized dispatch, and outputs optimized power commands 183A-N to energy storage nodes 105A-N and the PCSs 104A-N. In this example, power commands P_{cmd} 183A-B and battery current states (e.g., current 111B) from the energy storage nodes 105A-N are an input vector to cost model of battery degradation block 850. Power command 183A-B P_{cmd} and inverter current states from the PCSs 104A-N are an input vector to the cost model for PCS degradation block 855. The cost model for operating efficiency 860 is based on power commands P_{cmd} 183A-B. The goal of BLIM of the optimized dispatch programming 330A-B is to consider the state of each energy storage node 105A-N and PCS 104A-N, including degradation variables 701-705 of battery storage elements 106A-N and stress factors 721-723 of the PCSs 104A-N, as well as the operating efficiency 133 cost, to optimize the power commands 183A-N in order to maximize the lifetime of the energy storage nodes 105A-N and operate the energy storage nodes 105A-N and PCSs 104A-N at their most efficient operating point. A real-time optimization tuner block 885 uses the predicted degradation variables 701-705 for battery storage elements 106A-N and stress factors 721-723 of the PCSs 104A-N and the auxiliary power to compare with the actual sensed degradation variables 701-705 and stress factors 721-723. Blocks 880, 885 are described in more detail in FIG. 9.

Battery degradation is influenced by various key parameters, including temperature, cycle depth, frequency of cycling, charge/discharge current magnitude, rate of change of state of charge (SOC), terminal voltage, and cycling. Battery degradation can be measured at any level of the energy storage system 101, either collectively or discretely, from the entire energy storage system 101, through battery arrays 150, battery cores 151A-N, energy storage nodes 105A-N, battery cubes 230A-N, battery storage elements 106A-N, battery racks, battery modules, battery strings, down to the individual battery cells and sub-cells within the battery modules. Implementing optimized control strategies for batteries can lead to a significant reduction in degradation, and optimizing the performance of energy storage system 101 and degradation can be improved without impacting revenue generation. Based on experimental data and considering factors such as battery chemistry and operational services, it is estimated that even an improvement of 2% in degradation has a major impact on the profit.

In the first optimization function, the battery cost lifetime 131 optimization function (block 850) of the BLIM will enhance the overall customer profitability of the energy storage system 101 by extending the lifespan of batteries. In this example, a battery ideal operation profile 700 is used as an algorithm input. This battery ideal operation profile 700 can be derived from various sources such as research-based battery models or experimental data. The battery ideal operation profile 700 represents a multi-dimensional space of degradation variables 701-705 that the cost function employs to optimize the power command 183. FIG. 7A shows the parameters of the battery ideal operation profile 700. It can be seen the cycle times are not included in battery ideal operation profile 700 since battery ideal operation profile 700 is an add on to the existing control where the charge and discharge power command 183A-B has been determined in the upper level control function 805.

In other examples, the algorithm input may be a single value, or an array of different values. The single value can be an aggregation of multiple values, or itself the output of a formula or algorithm. The input values may be fixed, or variable, and may be instant measurements, or leading or lagging indicators.

Returning to the current example, the parameters of the battery ideal operation profile 700 impact the round-trip-efficiency (RTE) of batteries. Therefore, the optimization algorithm increases the efficiency of RTE as well. For example, equivalent series resistance (ESR) of batteries depend on the battery temperature and therefore the efficiency of batteries will be impacted by the temperature. There is also intercoupling between some of these variables such as temperature 701 and current magnitude 702. Thus, the optimized control method lowers the risk of thermal runaways where both high ambient temperatures and high current magnitude occur.

In optimal control, the state variables x(t) are the degradation variables 701-705 of the batteries and power command 183 is the control input u(t). Using this approach, the optimization is formulated as follows:

$$J = \int {x}^{2} ( t ) K x ( t ) dt$$

$$subject to x = f ( x ( t ) , u ( t ) ) ,$$

where J is the degradation cost function to be minimized. Gain vector K applies penalty for each of the degradation states.

The state space model represents the battery cost lifetime model. There are various battery cost lifetime models developed that are critical for the accuracy of the optimization of the energy storage nodes 105A-N. In this battery cost lifetime model, a black box model is considered using artificial intelligence. Using this approach, the following cost functions are developed for the active operation state mode for each energy storage node 105A-N:

$${CB}_{active} = [ {k}_{1} ( T - {T}_{max} ) + {k}_{2} ( I - {I}_{max} ) + {k}_{3} ( SOC - {SOC}_{max} ) + {k}_{4} ( SOC - {SOC}_{min} ) + {k}_{5} ( Δ SOC - Δ {SOC}_{max} ) + {k}_{6} ( V - {V}_{max} ) + {k}_{7} ( {V}_{min} - V ) ]$$

and the following model is considered for the idle operation state mode for each battery cube 230A-N:

$${CB}_{idle} = - [ {k}_{1} ( T - {T}_{max} ) + {k}_{2} ( I - {I}_{max} ) + {k}_{3} ( SOC - {SOC}_{max} ) + {k}_{4} ( SOC - {SOC}_{min} ) + {k}_{5} ( Δ SOC - Δ {SOC}_{max} ) + {k}_{6} ( V - {V}_{max} ) + {k}_{7} ( {V}_{min} - V ) + {k}_{8} ( t - {t}_{min} ) ]$$

Gains k₁ through k₈ are configurable penalty gains. tₘᵢₙ is the desired time to achieve full SOC. The last term k₈(t−tₘᵢₙ) is used to incorporate the need for a smaller recharge time in order to ensure the highest capacity available as fast as possible. In this example cycling (e.g., charging and discharging the energy storage nodes 105A-N) is not considered here. Cycling control is left to the upper level control function 805 to decide to cycle. These cost functions CB_{active} and CB_{idle} increase as the system stress state variables go above the optimum profile. If a state variable is exactly on the optimum point, the impact of that parameter will be zero; and if a state variable is negative, that is an indication of a more relaxed energy storage system 101, which allows room for adding more stress. Depending on the implementation, negative terms can be zeroed out if desired to only consider cost and neglect additional room for stress.

The second optimization function is the PCS cost lifetime 132 shown in block 855 as cost model for PCS degradation. The lifetime of an inverter is a function of stress factors 721-723 that impact mainly filter capacitors and switching semiconductors, such as insulated-gate bipolar transistors (IGBTs), field-effect transistors (FETs), etc. Degradation of capacitors and semiconductor switches can be delayed when the number and duration of stress factors 721-723 are reduced. FIG. 7B shows these parameters of the PCS ideal operation profile 720. The formula for CI below is the model of the cost function for the inverter lifetimes.

$$CI = [ {k}_{1} ( T - {T}_{max} ) + {k}_{2} ( I - {I}_{max} ) + {k}_{3} ( V - {V}_{max} ) + {k}_{4} ( {V}_{min} - V ) ]$$

Gains k₁ through k₄ are configurable penalty gains. This cost function CI increases as each of inverter stress factors 721-723 diverge from the optimum point. If a state variable is zero that state variable is not cause of stress, and if a state variable is negative, it indicates that the energy storage system 101 can take on higher stress. Like the battery cost functions CB_{active} and CB_{idle}, depending on the implementation, negative terms can be zeroed out if it desired to only consider cost and to neglect additional room for stress.

The third optimization function is the operating efficiency 133 cost function shown in block 860 as cost model for operating efficiency. The PCS 104 (e.g., inverter) and battery storage elements 106A-N have an efficiency curve that indicates the most efficient operation mode. PCSs 104A-N usually operate the most efficient at 75% loading. Using these efficiency curves, an efficiency function can be created for the entire energy storage system 101.

$$CE = [ {k}_{1} ϕ ( {P}_{i n v} ) + {k}_{2} ψ ( {P}_{batt} ) + {k}_{3} Ψ ( {P}_{a u x} ) ]$$

where Gains k₁, k₂ and k₃ are configurable penalty gains. Pᵢₙᵥ is the calculated individual power of each inverter 104, P_{batt} is the calculated individual power of each battery storage element 106A-N, and Pₐᵤₓ is the auxiliary power for the received power command 183 P_{cmd}. Functions φ, ψ, and Ψ are the cost functions associated with the deviation from the efficient operating points. These functions can be derived from the datasheets and specifications for the PCS 104 (e.g., inverter) and battery storage elements 106A-N. For example, φ can be defined as follows:

$$ϕ = \{ \begin{matrix}0 & if 75 \% {P}_{nom} < {P}_{inv} < {P}_{nom} \\ σ ( {P}_{inv} - {P}_{nom} ) & if 75 \% {P}_{nom} > {P}_{inv}\end{matrix}$$

In the above example for the PCS cost lifetime 132 function for the inverter efficiency, the inverter specification has indicated that the inverter is the most efficient at 75% or above of nominal power Pₙₒₘ. At percentages below 75% of nominal power, a linear cost function is defined which goes higher as the power gets lower with a coefficient σ.

Optimized dispatch programming 330A-B utilizes time periods that are allowed by requirements (e.g., performance contracts) to optimize the upper level control function 805. These utilizable times are called “flexible times”. Flexible times are operating periods when the energy storage system 101 is not engaged in critical services. During these intervals, optimized dispatch programming 330A-B optimizes operation of the energy storage system 101 by charging and discharging batteries (e.g., battery storage elements 106A-N of energy storage nodes 105A-N) to minimize degradation and losses to extend lifetime of the energy storage system 101.

FIG. 9 is another block diagram of the optimized dispatch protocol 400 implemented in the optimized dispatch programming 330A-B. The optimized dispatch programming 330A-B can include the BLIM which implements the supervisory control process of FIG. 9. Beginning block 905, the supervisory control process of the optimized dispatch programming 330A-B determines whether BLIM is enabled. If BLIM is disabled by an operator or by the upper level control function 805 of FIG. 8, then block 910 is entered, and the BLIM 500 is bypassed. As shown, block 910 of the optimized dispatch programming 330A-B bypasses the BLIM and results in the original power command P_{cmd} 183 to be directly outputted unaffected as the BLIM output

$${P}_{c m d}^{opt}$$

in block 880 of FIG. 8. The upper level control function block 805 of FIG. 8 determines to enable/disable the optimization feature based on the defined flexible times of the energy storage system 101. The original power command 183 P_{cmd} and optimized power command 183A

$${P}_{c m d}^{opt}$$

can be in the form of a vector of power commands 183A-N to each energy storage node 105A-N.

If the BLIM of the optimized dispatch programming 330A-B is not disabled by the operator or the upper level control function block 805, the BLIM is started in block 915, and commences the process of modifying the original power command 183 (P_{cmd}) into optimized power commands 183A-N

$$( {P}_{c m d}^{opt} ) .$$

Moving to block 920, the degradation variables 701-705, stress factors 721-723, and the original power command 183 (e.g. the power requested by the requirements or performance contract) are collected or measured for each energy node 105A-N. In block 925, the optimized dispatch programming 330A-B determines whether a power command 183 has been issued to the energy storage system 101. If a power command 183 has been issued to the energy storage system 101, the optimized dispatch programming 330A-B proceeds to block 930, where an AI optimization Active mode is run.

Proceeding to block 930, the AI optimization Active mode of the optimized dispatch programming 330A-B calculates the above CB_{active} function (battery cost lifetime 131), the CI function (PCS 132), cost lifetime and the CE function (operating efficiency 133), based on the degradation variables 705, stress factors 721-723, and original power command 183 collected in block 920 and the configurable penalty gains for each energy storage node 105A-N. Once an optimization value is reached, the original power command 183 (P_{cmd}) is modified based on the results of the CB_{active} function (battery cost lifetime 131), the CI function (PCS cost lifetime 132), and the CE function (operating efficiency 133) to produce the optimized power command 183A-N

$$( {P}_{c m d}^{opt} ) ,$$

which adjusts the performance of the energy storage system 101, energy storage nodes 105A-N, PCSs 104A-N, and their constituent parts based on the original power command 183, the CB_{active} (battery cost lifetime 131), CI (PCS cost lifetime 132), and CE function (operating efficiency 133) results.

If no power command 183 has been made of the energy storage system 101, the BLIM optimized dispatch programming 330A-B proceeds to block 935, where the AI optimization Idle mode is run. The AI optimization Idle mode calculates the above CB_{idle} function (battery cost lifetime 131), the CI function (PCS cost lifetime 132), and the CE function (operating efficiency 133), based on the degradation variables 701-705 and stress factors 721-723 collected in block 920 and the configurable penalty gains for each energy storage node 105A-N. Once an optimization value is reached, the original power command 183 (P_{cmd}) is modified based on the results of the CB_{idle} function (battery cost lifetime 131), the CI function (PCS cost lifetime 132), and the CE function (operating efficiency 133) to produce the optimized power command 183A-N

$$( {P}_{c m d}^{opt} )$$

command, which adjusts the performance of the energy storage system 101, energy storage nodes 105A-N, PCSs 104A-N, and their constituent parts based on the CB_{active} (battery cost lifetime 131), CI (PCS cost lifetime 132), and CE function (operating efficiency 133) results.

The optimized dispatch programming 330A-B is node-specific, allowing optimization of the power commands 183 for each inverter of the PCSs 104A-N and each energy storage node 105A-N. Optimized dispatch programming 330A-B dispatches the required power flow 112 based on the degradation variables 701-705 of each energy storage node 105A-N and the stress factors 721-723 of the PCSs 104A-N. To illustrate, if a first energy storage node 105A has higher temperature 701 due to a malfunctioning HVAC system, the optimized dispatch programming 330A-B seeks to satisfy a condition in which the optimized power command 183A-N

$$( {P}_{c m d}^{opt} )$$

does not cause excessive stress on the first energy storage node 105A.

After running either the Run AI optimization Idle mode in block 935, or the Run AI optimization Active mode in block 930, the optimized dispatch programming 330A-B proceeds to determine whether any state variable exceeded the optimum profile. Hence, degradation variables 701-705 of the energy storage nodes 105A-N are compared against the battery ideal operation profile 700, including a minimum range and a maximum range of a temperature 701A-B, a current magnitude 702A-B, a state of charge (SOC) 703A-B, a rate of change of SOC 704A-B, and a DC link voltage 705A-B. Additionally, the stress factors 721-723 of the PCSs 104A-N are compared against the PCS ideal operation profile 720, including the minimum range and a maximum range of a temperature 721A-B, a current magnitude 722A-B, and a DC link voltage 723A-B.

If the state variables do not exceed the optimum profile in the comparison of block 940, then the optimized dispatch programming 330A-B exits the BLIM in block 950. However, if any state variable exceeds the optimum profile in the comparison of block 940, then block 945 is reached. In block 945, the optimization penalty gains are updated for the associated state (Active or Idle). After block 945, the optimized dispatch programming 330A-B returns to either the active mode block 930 or the idle mode block 935, depending upon which was most recently executed.

The above cost functions for battery cost lifetime 131, PCS cost lifetime 132, and operating efficiency 133 can be directly used as the model for the degradation of battery storage elements 106A-N, degradation of the PCSs 104A-N, and the operating efficiency 133. Each model can be an analytical model or an artificial intelligence-based model. In another example, an intermediate step could be added to first process the degradation variables 701-705 of the battery ideal operation profile 700 and stress factors 721-723 of the PCS ideal operation profile 720 in a defined model, and then using these variables to calculate the cost functions 131-133 above. However, the first method is compressed with improved processing. The above cost functions 131-133 can be defined by different functions, such as higher order terms.

In the examples above, the energy system 102, energy application 103, power conversion system 104, energy storage nodes 105A-N, control subsystem 110, control system 115, array controller 170, core controllers 171A-N, node controllers 172A-N, enclosure controllers 173A-N, etc. each include a network communication interface 161, 311, 351 for wired or wireless communication over one or more networks 305A-N. The networks 305A-N interconnect the links to/from the network communication interfaces 161, 311, 351 of the devices, so as to provide data communications amongst the energy application 103, energy storage nodes 105A-N, control system 115, array controller 170, core controllers 171A-N, node controllers 172A-N, enclosure controllers 173A-N, etc. Networks 305A-N may support data communication by equipment at the premises via wired (e.g., cable or fiber) media or via wireless (e.g., Wi-Fi, Bluetooth™, ZigBee, LiFi, IrDA, etc.) or combinations of wired and wireless technology.

Any of the functionality of the optimized dispatch protocol 400, including optimized dispatch programming 330A-B, described herein for the energy system 102, electrical application 103, power conversion system 104, energy storage nodes 105A-N, control subsystem 110, control system 115, array controller 170, core controllers 171A-N, node controllers 172A-N, enclosure controllers 173A-N, etc. can be embodied in one more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language).

In the examples above, the energy system 102, energy application 103, power conversion system 104, energy storage nodes 105A-N, control subsystem 110, control system 115, array controller 170, core controllers 171A-N, node controllers 172A-N, enclosure controllers 173A-N, etc. can each include a processor. As used herein, a processor 162, 312, 352 is a hardware circuit having elements structured and arranged to perform one or more processing functions, typically various data processing functions. Although discrete logic components could be used, the examples utilize components forming a programmable central processing unit (CPU). A processor 162, 312, 352 for example includes or is part of one or more integrated circuit (IC) chips incorporating the electronic elements to perform the functions of the CPU. The processors 162, 312, 352 for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 162, 312, 352 can include one microprocessor or a multi-processor architecture. A digital signal processor (DSP) or field-programmable gate array (FPGA) could be suitable replacements for the processors 162, 312, 352, but may consume more power with added complexity.

The applicable processor 162, 312, 352 executes programming or instructions to configure the energy system 102, energy application 103, power conversion system 104, energy storage nodes 105A-N, control subsystem 110, control system 115, array controller 170, core controllers 171A-N, node controllers 172A-N, enclosure controllers 173A-N, etc. to perform various operations. For example, such operations may include various general operations (e.g., a clock function, recording and logging operational status and/or failure information) as well as various system-specific operations (e.g., energy management) functions. Although a processor 162, 312, 352 may be configured by use of hardwired logic, typical processors are general processing circuits configured by execution of programming, e.g., instructions and any associated setting data from the memories 163, 313, 353 shown or from other included storage media and/or received from remote storage media.

In the examples above, the energy system 102, energy application 103, power conversion system 104, energy storage nodes 105A-N, control subsystem 110, control system 115, array controller 170, core controllers 171A-N, node controllers 172A-N, enclosure controllers 173A-N, etc. each include a memory. The memory 163, 313, 353 may include a flash memory (non-volatile or persistent storage), a read-only memory (ROM), and a random access memory (RAM) (volatile storage). The RAM serves as short term storage for instructions and data being handled by the processors 162, 312, 352 e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplar embodiments described herein. The processor(s) can be configured to include and perform features of the exemplary embodiments of the present disclosure, such as the optimized dispatch protocol 400 and the optimized dispatch programming 330A-B. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the optimized dispatch protocol 400 and the optimized dispatch programming 330A-B, can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 162, 312, 352 can be included in a computing system that is configured with components such as memory, a hard drive, an input/output (I/O) interface, a communication interface, a display and any other suitable component as desired. The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, or any other suitable network communication interface as desired. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including the optimized dispatch protocol 400 and the optimized dispatch programming 330A-B, the programming or software can be stored in a computer program product or non-transitory computer readable medium and loaded into the computing device using a removable storage drive or communications interface. In an exemplary embodiment, any computing device, such as control subsystem 110, control system 115 and controllers 170-173, disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element. Unless otherwise stated, the articles “a” or “an” preceding an element mean one or more of the elements.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

What is claimed is:

1. An energy storage system, comprising:
a power conversion system (PCS);
a plurality of energy storage nodes, wherein the plurality of energy storage nodes include:
a battery storage element, and
a control subsystem to receive battery data from the battery storage element, PCS data from the power conversion system, or a combination thereof; and
a control system coupled to the plurality of energy storage nodes and configured to receive or store a required power flow;
wherein the control system is configured to:
receive or store the required power flow for an electrical application; and
dispatch the required power flow across the plurality of energy storage nodes based on at least two of: (a) a battery cost lifetime of the battery storage element; (b) a PCS cost lifetime of the PCS; and (c) an operating efficiency of the battery storage element and the PCS.

2. The energy storage system of claim 1, wherein the battery cost lifetime is based on a battery ideal operation profile derived from research-based battery models or experimental data.

3. The energy storage system of claim 2, wherein the battery ideal operation profile includes at least one of a minimum range and a maximum range of a temperature, a current magnitude, a state of charge (SOC), a rate of change of SOC, and a DC link voltage.

4. The energy storage system of claim 2, wherein the dispatch based on the battery cost lifetime is responsive to a cost function of degradation variables of the battery storage element to optimize a power command.

5. The energy storage system of claim 1, wherein the PCS cost lifetime of the PCS is based on a function of one or more stress factors that impact at least one of a filter capacitor and a switching semiconductor of the PCS.

6. The energy storage system of claim 5, wherein the PCS cost lifetime is based on a PCS ideal operation profile derived from research-based PCS models or experimental data.

7. The energy storage system of claim 6, wherein the PCS ideal operation profile includes at least one of a minimum range and a maximum range of a temperature, a current magnitude, and a DC link voltage.

8. The energy storage system of claim 1, wherein the operating efficiency is based on a function to maximize an efficiency curve of the PCS and the battery storage element.

9. A non-transitory computer-readable medium, comprising optimized dispatch programming, wherein execution of the optimized dispatch programming by one or more processors configures one or more controllers to:
receive or store a required power flow for an electrical application; and
dispatch the required power flow across a plurality of energy storage nodes based on at least two of: (a) a battery cost lifetime of a battery storage element; (b) a power conversion system cost lifetime of a power conversion system (PCS); and (c) an operating efficiency of the battery storage element and the PCS.

10. The non-transitory computer-readable medium of claim 9, wherein the battery cost lifetime is based on a battery ideal operation profile derived from research-based battery models or experimental data.

11. The non-transitory computer-readable medium of claim 10, wherein the battery ideal operation profile includes at least one of a minimum range and a maximum range of a temperature, a current magnitude, a state of charge (SOC), a rate of change of SOC, and a DC link voltage.

12. The non-transitory computer-readable medium of claim 10, wherein the dispatch based on the battery cost lifetime is responsive to a cost function of degradation variables of the battery storage element to optimize a power command.

13. The non-transitory computer-readable medium of claim 9, wherein the PCS cost lifetime of the PCS is based on a function of one or more stress factors that impact at least one of a filter capacitor and a switching semiconductor of the PCS.

14. The non-transitory computer-readable medium of claim 13, wherein the PCS cost lifetime is based on a PCS ideal operation profile derived from research-based PCS models or experimental data.

15. The non-transitory computer-readable medium of claim 14, wherein the PCS ideal operation profile includes at least one of a minimum range and a maximum range of a temperature, a current magnitude, and a DC link voltage.

16. The non-transitory computer-readable medium of claim 9, wherein the operating efficiency is based on a function to maximize an efficiency curve of the PCS and the battery storage element.

17. A method, comprising:
receiving or storing a required power flow for an electrical application; and
dispatching the required power flow across the plurality of energy storage nodes based on at least two of: (a) a battery cost lifetime of a battery storage element; (b) a power conversion system cost lifetime of a power conversion system (PCS); and (c) and an operating efficiency of the battery storage element and the PCS.

18. The method of claim 17, wherein the battery cost lifetime is based on a battery ideal operation profile derived from research-based battery models or experimental data.

19. The method of claim 18, wherein the battery ideal operation profile includes at least one of a minimum range and a maximum range of a temperature, a current magnitude, a state of charge (SOC), a rate of change of SOC, and a DC link voltage.

20. The method of claim 18, wherein the dispatching based on the battery cost lifetime is responsive to a cost function of degradation variables of the battery storage element to optimize a power command.
